(19) United States
(12) Patent Application Publication
(10) Pub. No.: US 2026/0119543 A1
(43) Pub. Date: Apr. 30, 2026

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: NEC Corporation, Tokyo (JP)

(72) Inventor: Tomoya BELL, Tokyo (JP)

(73) Assignee: NEC Corporation, Tokyo (JP)

(21) Appl. No.: 19/355,110

(22) Filed: Oct. 10, 2025

(30) Foreign Application Priority Data
Oct. 31, 2024 (JP) 2024-191288

(51) Int. Cl. G06F 16/3329; G06F 21/32; G06V 40/16

(52) U.S. Cl. CPC G06F 16/33295; G06F 21/32; G06V 40/174

(57) ABSTRACT

An information processing apparatus includes a storage means and a service control means. The storage means stores a plurality of learning models and information of each of the plurality of learning models. The service control means implements a service that answers a question from a service user by using at least one or more learning models among the plurality of learning models. The service control means selects the learning model that answers the question from the service user from among the plurality of learning models, based on information of the service user and information of each of the plurality of learning models.

### INCORPORATION BY REFERENCE

This application is based upon and claims the benefit of priority from Japanese Patent Application No. 2024-191288, filed on October 31, 2024, the disclosure of which is incorporated herein in its entirety by reference.

### TECHNICAL FIELD

The present disclosure relates to an information processing apparatus, a control method of an information processing apparatus, and a non-transitory computer-readable storage medium.

### BACKGROUND ART

There exists a technology that realizes communication targeted at a deceased person or the like.

For example, Patent Literature 1 (JP2015-176058 A) describes that there is provided an electronic device, a method, and a program for interactively outputting information related to a person or an animal that existed in the past.

The electronic device of Patent Literature 1 includes a storage means, a speech recognition means, a message generation means, and a speech synthesis means.

The storage means stores information related to a person or an animal that existed in the past. The speech recognition means identifies a content of speech uttered by a user. The message generation means generates a message for conveying to another user the content of the speech identified by the speech recognition means. The speech synthesis means synthesizes a voice of a person or an animal based on the information stored in the storage means and the message.

With the development of recent AI (Artificial Intelligence) related technologies, there exist services in which a learning model obtained by machine learning is used as a conversation partner. The learning models used in such services are often trained using utterances or the like of many individuals as training data. Therefore, much of the content output by the learning model is commonplace and often not content with which users are satisfied. Therefore, there are cases where user satisfaction in a conversation service using a learning model is low.

It should be noted that Patent Literature 1 merely discloses a technology for outputting a voice of a person or the like who existed in the past. Accordingly, even if the technology disclosed in Patent Literature 1 is applied, the above problem cannot be solved.

### SUMMARY

It is a main object of the present disclosure to provide an information processing apparatus, a control method of an information processing apparatus, and a non-transitory computer-readable storage medium that contribute to improving a satisfaction level of a user who uses a conversation service using a learning model.

According to a first aspect of the present disclosure, there is provided an information processing apparatus including: a storage means that stores a plurality of learning models and information of each of the plurality of learning models; and a service control means that implements a service that answers a question from a service user by using at least one or more learning models among the plurality of learning models, and wherein the service control means selects the learning model that answers the question from the service user from among the plurality of learning models, based on information of the service user and information of each of the plurality of learning models.

According to a second aspect of the present disclosure, there is provided a control method of an information processing apparatus, the control method including: storing a plurality of learning models and information of each of the plurality of learning models; implementing a service that answers a question from a service user by using at least one or more learning models among the plurality of learning models; and selecting the learning model that answers the question from the service user from among the plurality of learning models, based on information of the service user and information of each of the plurality of learning models.

According to a third aspect of the present disclosure, there is provided a non-transitory computer-readable storage medium storing a program causing a computer mounted on an information processing apparatus to perform processing for: storing a plurality of learning models and information of each of the plurality of learning models; implementing a service that answers a question from a service user by using at least one or more learning models among the plurality of learning models; and selecting the learning model that answers the question from the service user from among the plurality of learning models, based on information of the service user and information of each of the plurality of learning models.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment of the present disclosure;

FIG. 4 is a diagram illustrating an operation of the information processing system according to the embodiment of the present disclosure;

FIG. 5 is a diagram illustrating an operation of the information processing system according to the embodiment of the present disclosure;

FIG. 6 is a diagram illustrating an operation of the information processing system according to the embodiment of the present disclosure;

FIG. 7 is a diagram illustrating an example of a processing configuration of a server apparatus according to the embodiment of the present disclosure;

FIG. 8 is a diagram illustrating an example of a learning model management database according to the embodiment of the present disclosure;

FIG. 9 is a diagram illustrating an example of a user management database according to the embodiment of the present disclosure;

FIG. 10 is a flowchart illustrating an example of an operation of a service control unit according to the embodiment of the present disclosure;

FIG. 11 is a diagram illustrating an example of a display of a terminal according to a variation of the embodiment of the present disclosure;

FIG. 12 is a diagram illustrating an example of a display of the terminal according to the variation of the embodiment of the present disclosure;

FIG. 13 is a diagram illustrating an example of a schematic configuration of the information processing system according to the variation of the embodiment of the present disclosure; and

FIG. 14 is a diagram illustrating an example of a hardware configuration of the server apparatus according to the present disclosure.

### EXAMPLE EMBODIMENT

First, an outline of an example embodiment will be described. It should be noted that in the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

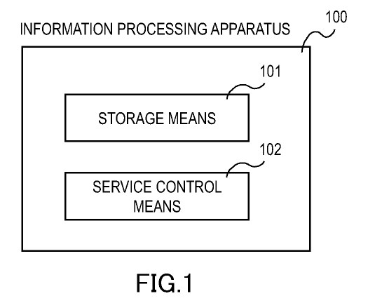

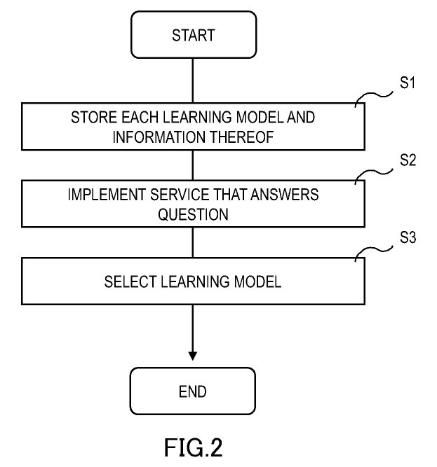

An information processing apparatus 100 according to an example embodiment includes a storage means 101 and a service control means 102 (see FIG. 1). The storage means 101 stores a plurality of learning models and information of each of the plurality of learning models (step S1 in FIG. 2). The service control means 102 implements a service that answers a question from a service user by using at least one or more learning models among the plurality of learning models (step S2). The service control means 102 selects the learning model that answers the question from the service user from among the plurality of learning models, based on information of the service user and information of each of the plurality of learning models (step S3).

The information processing apparatus 100 provides a conversation service using a learning model. The information processing apparatus 100 selects a learning model suitable for a user receiving the provision of a service from among the plurality of learning models. The information processing apparatus 100 answers a question from the user by using the selected learning model. For example, the information processing apparatus 100 selects an optimal learning model from among the plurality of learning models based on an attribute of the user. As a result, satisfaction of the user using the conversation service with the learning model is improved.

Hereinafter, specific example embodiments will be described in more detail with reference to drawings.

### First Example Embodiment

A first example embodiment will be described in more detail with reference to drawings.

### Configuration of System

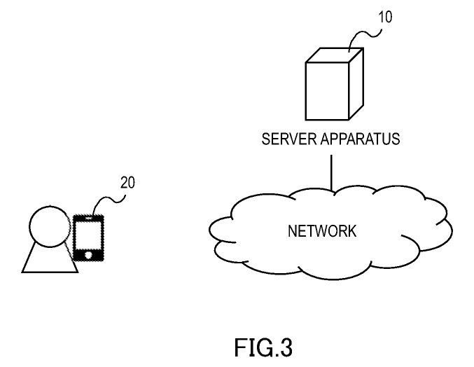

As shown in FIG. 3, an information processing system according to the first example embodiment includes a server apparatus 10.

The server apparatus 10 is operated by a business operator that provides a conversation service in which a user and a learning model (AI model) converse.

In the first example embodiment, a case where the server apparatus 10 provides a service (a question answering service) that gives advice on a question, an inquiry, a concern, or the like of a user will be taken as an example, and the configuration and so on of the information processing system will be described. For example, the server apparatus 10 provides a service of giving an answer to a work-related question, inquiry, concern, or the like that a user has.

The server apparatus 10 is a server that realizes principal operations of the business operator providing the above conversation service. The server apparatus 10 may be installed in a building of the service providing business operator, or may be installed on a network (in a cloud).

A user has a terminal 20 such as a smartphone or a tablet. The user operates the terminal 20 to input various information to the server apparatus 10 or the like and to acquire various information from the server apparatus 10 or the like.

The respective apparatuses shown in FIG. 3 are connected to each other. Specifically, the server apparatus 10 and the terminal 20 are connected by wired or wireless communication means and are configured to be able to communicate with each other.

The configuration of the information processing system shown in FIG. 3 is an example and is not intended to limit the configuration of the authentication system. For example, the information processing system may include a plurality of server apparatuses 10. Load balancing and redundancy may be achieved by the plurality of server apparatuses 10.

### Schematic Operation

Next, a schematic operation of the information processing system according to the first example embodiment will be described.

### Preparing learning model

The server apparatus 10 provides the above question answering service using an AI (Artificial Intelligence) model (learning model) obtained by machine learning. The service providing business operator prepares the learning model used for the question answering service.

The service providing business operator prepares a plurality of learning models, each of which gives a different answer (output) to a question (input). The service providing business operator appropriately selects training data used for generating the learning models so that a feature (an individuality) is given to an answer of each learning model.

For example, the service providing business operator generates a learning model that outputs an answer reflecting a way of thinking or the like of one person by using utterances of the one person as training data. For example, the service providing business operator generates a learning model by using utterances of a founder of a company that has achieved great success, a well-known business manager, or the like (utterances obtained from a book authored by the well-known business manager or the like).

Alternatively, the service providing business operator may generate the learning model by using, as training data, utterances in a television program or the like of a business manager who is a target of generation of the learning model, or messages posted on a weblog (so-called blog) or an SNS (Social Networking Service) or the like.

It should be noted that the service providing business operator prepares each of the plurality of learning models described above as a Large Language Model (LLM). In addition, a person who is a target of generation of the learning model (for example, a well-known business manager or the like) may be a deceased person or a living person. It should be noted that the person who is a target of generation of the learning model may be a virtual person (for example, a fictional person who appears in a novel, a game, or the like). In addition, it is preferable that the generation of the learning model be performed after the person who is a target of generation of the learning model or a bereaved family of the person has given consent to the generation of the learning model.

As described above, each of the plurality of learning models used in the present disclosure is a learning model in which a way of thinking of one person (for example, a well-known business manager or the like) is reflected.

### Account Generation

A user (for example, an office worker) generates an account with the service providing business operator in order to receive provision of the conversation service. Specifically, the user operates the terminal 20 to access the server apparatus 10. The user inputs a name, a gender, a date of birth, an address, a telephone number, an e-mail address, biometric information, work history information, educational background information, or the like into a user registration site provided by the server apparatus 10.

It should be noted that examples of the biometric information include data (feature values) calculated from physical features unique to an individual, such as a face, a fingerprint, a voiceprint, a vein, a retina, or an iris pattern of an eye. Alternatively, the biometric information may be image data such as a face image or a fingerprint image. The biometric information may be anything that includes physical characteristics of a user as information. In the example embodiment of the present disclosure, a case where biometric information related to a "face" of a person (a face image or a feature value generated from the face image) is used will be described.

Work history information is information related to a current or past workplace or job description of a user. For example, the work history information includes a company name of a current or past workplace, a job type (an affiliated department), a job title, or the like. Educational background information is information related to a high school, a university, or the like from which a user graduated. For example, the educational background information includes a university name, a graduation department, a graduation year, or the like.

Upon acquiring a name and the like of a user, the server apparatus 10 generates a user ID for identifying the user. The server apparatus 10 associates and stores the user ID, the name, the date of birth, the biometric information, and the like. The server apparatus 10 stores the user ID, the name, the biometric information, and the like in a user management database. Details of the user management database will be described below.

By generating an account with the service providing business operator, the user is able to receive provision of the question answering service (the conversation service).

### Installation of Application

In order to receive provision of the question answering service, a user installs a dedicated application on the terminal 20. For example, the user operates the terminal 20 to access the server apparatus 10 or a predetermined website, and downloads the dedicated application. The user installs the downloaded dedicated application in the terminal 20.

### Start of Use of Service

A user who desires to use the question answering service is authenticated by the server apparatus 10. Specifically, the user starts up the dedicated application installed on the terminal 20. The application acquires biometric information of the user (for example, a face image).

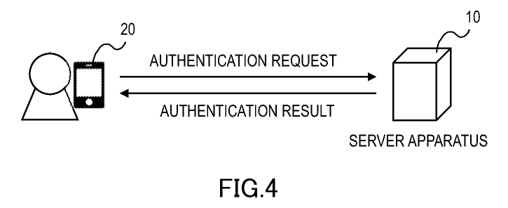

The terminal 20 (the dedicated application) transmits an authentication request including the acquired biometric information to the server apparatus 10 (see FIG. 4). For example, the terminal 20 transmits to the server apparatus 10 an authentication request including a face image acquired by a selfie.

The server apparatus 10 performs biometric authentication using the biometric information included in the authentication request and a plurality of pieces of biometric information stored in a user management database. The server apparatus 10 identifies a user (a service user) who intends to receive provision of the conversation service by performing biometric authentication.

The server apparatus 10 transmits an authentication result (authentication success, authentication failure) to the terminal 20.

In a case where authentication is successful, the user is able to enjoy the conversation service.

Here, in a case where authentication of the user is successful, the server apparatus 10 selects a learning model for answering a question from the user from among a plurality of learning models. The server apparatus 10 selects an optimal learning model to answer the question from the user.

For example, in a case where three learning models exist, including a learning model A generated from utterances of a business manager A, a learning model B generated from utterances of a business manager B, and a learning model C generated from utterances of a business manager C, one learning model is selected from among the three learning models.

The server apparatus 10 selects one learning model from among the plurality of learning models using information of the user and information of each of the plurality of learning models.

For example, the server apparatus 10 selects one learning model from among the plurality of learning models based on attribute information of the user (an age group, a gender, an educational background, a work history, or the like). It should be noted that the attribute information of the user is an example of the information of the user.

For example, the server apparatus 10 selects a learning model corresponding to a business manager related to a workplace of the user. In the above example, in a case where the business manager A is a founder of a company in which the user works, the learning model A corresponding to the business manager A is selected as a learning model that answers a question of the user.

### Conversation with Learning Model

The authenticated user starts a conversation with the learning model selected by the server apparatus 10.

To begin with, the user inputs into the server apparatus 10 a question, an inquiry, a concern, or the like that the user desires to resolve via the terminal 20. For example, the user utters to the terminal 20 a concern or the like that the user desires to resolve. Alternatively, the user may input into the server apparatus 10 a concern or the like that the user desires to resolve by using an image, a text, or the like. That is, the information processing system according to the present disclosure may support multimodal input and output of information.

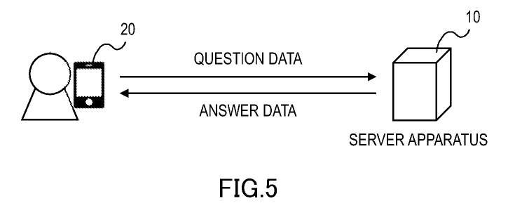

The terminal 20 converts voice data acquired via a microphone into text data. The terminal 20 transmits the acquired text data as "question data" to the server apparatus 10 (see FIG. 5).

The server apparatus 10 generates a prompt for input to a learning model from the acquired question data (text data related to a concern or the like of the user). The server apparatus 10 obtains an answer from the learning model by inputting the generated prompt into the learning model.

The server apparatus 10 transmits the acquired answer to the terminal 20. Specifically, the server apparatus 10 transmits text data of the acquired answer as "answer data" to the terminal 20.

The terminal 20 converts the acquired answer data (text data including an answer) into voice data and outputs the voice data from a speaker.

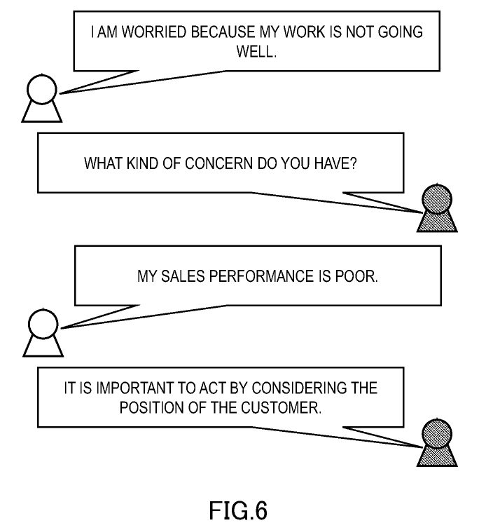

The user continues a conversation with the learning model until the user feels that a concern or the like has been resolved (see FIG. 6). It should be noted that, in FIG. 6, a white-colored person represents the user who uses the conversation service, and a gray-colored person represents the learning model.

Next, details of the individual apparatuses included in the information processing system according to the first example embodiment will be described.

### Server Apparatus

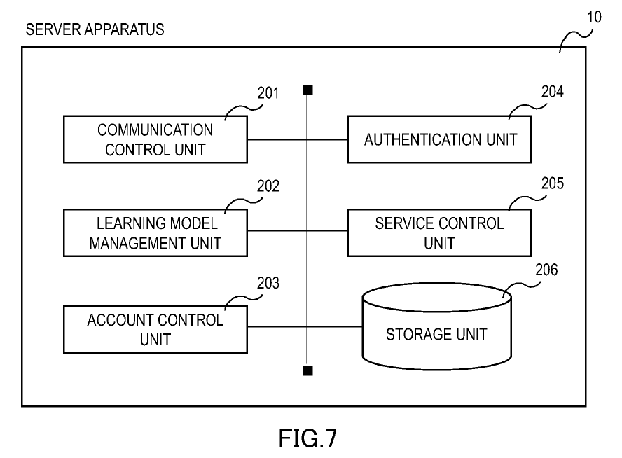

FIG. 7 is a diagram illustrating an example of a processing configuration (processing modules) of the server apparatus 10 according to the example embodiment of the present application. Referring to FIG. 7, the server apparatus 10 includes a communication control unit 201, a learning model management unit 202, an account control unit 203, an authentication unit 204, a service control unit 205, and a storage unit 206.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The learning model management unit 202 is means for performing control and management related to the learning models.

The learning model management unit 202 acquires a plurality of learning models (a plurality of learning models characterized by training data) prepared by a system administrator or the like.

At that time, the learning model management unit 202 also acquires related information for each learning model. For example, the learning model management unit 202 acquires, from the system administrator or the like, information of a person whose way of thinking or the like is reflected in the learning model (person information; for example, a profile including a name of the person), information related to training data used for generating the learning model (training data information), and the like.

For example, the learning model management unit 202 acquires each learning model and information related to each learning model by using a GUI (Graphical User Interface). Alternatively, the learning model management unit 202 may acquire each learning model and related information thereof via a USB (Universal Serial Bus) memory or the like.

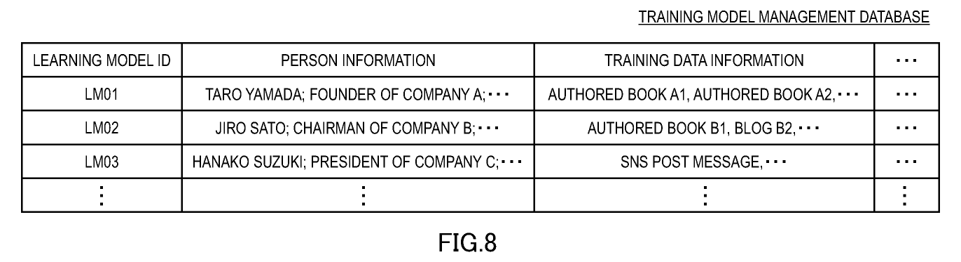

The learning model management unit 202 assigns an ID (a learning model ID) to the acquired learning model. The learning model management unit 202 stores the assigned learning model ID and information of the learning model in a learning model management database (see FIG. 8). It should be noted that the learning model management database shown in FIG. 8 is an example and is not intended to limit items to be stored. For example, a face image of a person corresponding to the learning model may be stored in the learning model management database.

Next, an outline will be given regarding the learning model and generation of the learning model.

A learning model is a model that generates an answer corresponding to a request. As an example, in a case where a prompt (a query) generated based on a request or the like from a user is input, the learning model outputs an answer corresponding to the prompt.

As an example, a learning model is configured by a language model. The language model may be, for example, what is referred to as an LLM (Large Language Model), but is not limited thereto.

A language model is a machine learning model (also referred to as a generative model) that inputs language and outputs language. The language model has learned relationships between words in a sentence, and is a model that generates a related character string related to a target character string from the target character string. By using a language model trained on sentences and texts in various contexts, it is possible to generate a related character string of reasonable content related to the target character string.

For example, a case where a language model is used in question answering will be described. The language model receives, as a target character string, input of a question "What kind of country is Japan?". The language model generates a character string such as "Japan is an island country in the Northern Hemisphere." as an answer to the question.

A learning method of the language model is not particularly limited, but as an example, the language model may be trained to output at least one sentence including an input character string. As a specific example, the language model is a GPT (Generative Pre-trained Transformer) that outputs a sentence including the input character string by predicting a character string having a high probability of following the input character string.

In addition, for example, T5 (Text-to-Text Transfer Transformer), BERT (Bidirectional Encoder Representations from Transformers), RoBERTa (Robustly optimized BERT approach), ELECTRA (Efficiently Learning an Encoder that Classifies Token Replacements Accurately), or the like is also a language model.

Content generated by a language model is not limited to character strings. The language model may generate, for example, image data, video data, audio data, or another data format corresponding to an input character string.

A learning model (a language model) is generated based on training data. For example, in a case where a learning model reflecting a way of thinking of a specific business manager is generated, diverse training data (data resources) such as public utterances of the business manager in media or the like and authored books of the business manager are utilized, and training (learning) of the learning model is performed.

Alternatively, a learning model having a specific individuality may be generated by utilizing an existing learning model (a language model). For example, transfer learning (fine-tuning) may be performed in which weights of a pre-generated learning model are trained with new training data. Specifically, by using an existing language model and performing additional training with unique training data (a dataset), a feature may be given to a learning model. For example, by preparing utterances of a specific business manager as training data and additionally training a basic learning model with the training data, characterization (personalization) of the learning model may be performed.

A "feedback" technique may be used in generation of a learning model. For example, an evaluator (a generator of the learning model) or the like determines appropriateness for feedback on an output from a learning model. The determination result is used as training data and retraining is performed. As a result, performance (output accuracy) of the learning model is improved. For example, in a case where a learning model reflecting a way of thinking of a specific business manager is generated, an evaluator (the generator of the learning model) may provide feedback so that an output result of the learning model "becomes closer to the specific business manager."

It should be noted that, with respect to characterization (personalization) of a learning model, in addition to generation of a learning model by training data, characterization of the learning model by so-called "prompt engineering" may also be performed. That is, by devising a question or an instruction (a prompt) to be input to the learning model, an output of the learning model may be guided (specified) in a designated manner. For example, in a case where an answer similar to a specific business manager is desired, a fixed phrase such as "Please think like business manager A" may be input to the learning model. Alternatively, related utterances or the like of a specific business manager may be acquired from a database, and utterances acquired from the database may be input to the learning model together with the fixed phrase.

The account control unit 203 is means for performing control related to an account of a user.

The account control unit 203 acquires, at a user registration site, a name, a gender, an address, a date of birth, a telephone number, an e-mail address, biometric information, work history information, educational background information, or the like of a user.

Upon acquiring a face image as biometric information, the account control unit 203 generates feature values from the face image. Since existing technologies can be used for processing of generating the feature values by the account control unit 203, a detailed description will be omitted. For example, the account control unit 203 extracts eyes, a nose, a mouth, and the like as feature points from the face image. Thereafter, the account control unit 203 calculates positions of the respective feature points and distances between the feature points as feature values (a feature vector composed of a plurality of feature values is generated).

Upon acquiring a name or the like, the account control unit 203 generates a user ID for identifying the user. The user ID may be any information as long as the information can uniquely identify the user. For example, the account control unit 203 may assign a unique value at each account generation and use the value as the user ID.

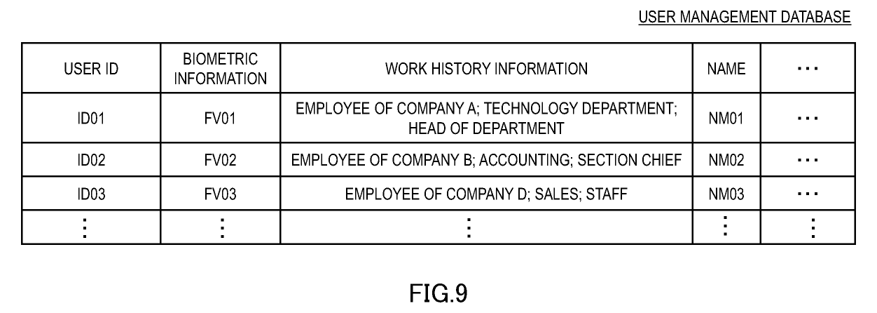

The account control unit 203 stores a name, a gender, biometric information, work history information, or the like in a user management database (see FIG. 9). It should be noted that the user management database shown in FIG. 9 is an example and is not intended to limit items to be stored.

The authentication unit 204 is means for performing authentication of a user (a person to be authenticated, a service user) who intends to enjoy the conversation service. Upon receiving an authentication request from the terminal 20, the authentication unit 204 performs authentication processing using biometric information included in the request.

The authentication unit 204 performs matching processing using biometric information (a face image) included in the authentication request and biometric information stored in the user management database.

Specifically, the authentication unit 204 generates a feature value from a face image included in the authentication request. The authentication unit 204 sets the generated feature value as a verification target, and performs matching processing (one-to-N matching; N is a positive integer, the same applies hereinafter) between the verification target and each of a plurality of feature values stored in the user management database.

The authentication unit 204 calculates similarity between the verification target feature value and each of the plurality of registered feature values. For the individual similarity, the chi-squared distance, the Euclidean distance, or the like may be used. It should be noted that a longer distance represents a lower similarity, and a shorter distance represents a higher similarity.

The authentication unit 204 determines that the matching processing has failed in a case where none of the plurality of feature values stored in the user management database has similarity equal to or greater than a predetermined value with the verification target feature values.

The authentication unit 204 determines that the matching processing has succeeded in a case where at least one of the plurality of feature values registered in the user management database has similarity equal to or greater than a predetermined value with the verification target feature values.

In a case where the matching processing has failed, the authentication unit 204 determines that authentication of the person to be authenticated has failed.

In a case where the matching processing has succeeded, the authentication unit 204 determines that authentication of the person to be authenticated has succeeded. Further, in a case where the matching processing has succeeded, among the plurality of entries registered in the user management database, a user of an entry having the highest similarity feature values is specified as the person to be authenticated (the user who intends to enjoy the conversation service).

The authentication unit 204 notifies the terminal 20 of an authentication result (authentication success, authentication failure). In a case of authentication success, the authentication unit 204 transmits a positive response indicating the success to the terminal 20. In a case of authentication failure, the authentication unit 204 transmits a negative response indicating the failure to the terminal 20.

It should be noted that, in a case where authentication of the person to be authenticated has succeeded, the authentication unit 204 passes a user ID of a user (a user who intends to enjoy the conversation service) specified by the matching processing to the service control unit 205.

As described above, the authentication unit 204 receives biometric information of an applicant who intends to enjoy the service from the terminal 20, and executes matching processing using the received biometric information and a plurality of biometric information stored in the user management database. By executing the matching processing, the authentication unit 204 authenticates a service user.

The service control unit 205 is means for executing control related to the conversation service.

The service control unit 205 realizes a service for answering a question from a service user by using at least one or more learning models among a plurality of learning models. At that time, the service control unit 205 selects a learning model for answering the question from the service user from among the plurality of learning models, based on information of the service user and information of each of the plurality of learning models.

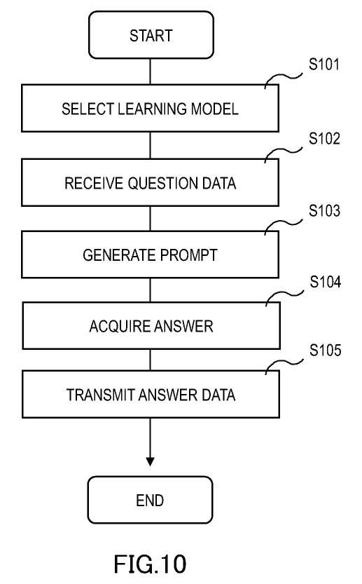

FIG. 10 is a flowchart illustrating an example of an operation of the service control unit 205 according to the example embodiment of the present disclosure. Referring to FIG. 10, an operation of the service control unit 205 will be described.

Upon acquiring a user ID from the authentication unit 204, the service control unit 205 selects a learning model for answering a question from the user (step S101).

For example, the service control unit 205 selects a learning model for conversing with the user based on attribute information of the user (for example, age group, gender, educational background, work history, or the like). It should be noted that the attribute information of the user is an example of information of the user.

For example, the service control unit 205 selects a learning model corresponding to a living business manager for a young user. For example, the service control unit 205 selects a learning model generated based on utterances of an incumbent business manager of a major Information Technology (IT) company.

Alternatively, the service control unit 205 selects a learning model corresponding to a business manager of a widely known company for an elderly user. For example, the service control unit 205 selects a learning model generated based on utterances of a founder of a long-established company.

The service control unit 205 selects a learning model as a conversation partner of the user with reference to table information that associates attribute information of the user (for example, age group, gender, or the like) with a learning model to be selected. It should be noted that the table information is created by a service providing business operator in accordance with the attribute information of the user and information of each learning model (for example, a profile of a person whose thinking is reflected in the learning model).

Alternatively, the service control unit 205 may select a learning model for conversing with the user based on educational background or work history of the user. The service control unit 205 may select a learning model based on educational background information or work history information of the user and person information stored in a learning model management database.

For example, the service control unit 205 selects a learning model reflecting thinking of a business manager related to a company in which the user works. Alternatively, the service control unit 205 may select a learning model corresponding to a business manager in the same industry as the company in which the user works. For example, in a case where the user works for a company in the electric industry, the service control unit 205 selects a learning model corresponding to a business manager who is well known in the electric industry.

Alternatively, the service control unit 205 may select a learning model corresponding to a business manager who graduated from the same university as the user.

The service control unit 205 may use a learning model (a large language model) different from a learning model for conversation with the user, to select the learning model for conversation. For example, the service control unit 205 may instruct a large language model to select an optimal learning model for the user by using attribute information of the user and person information in the learning model management database.

Alternatively, the service control unit 205 may select a learning model as a conversation partner of the user based on a prepared policy (a learning model selection policy). For example, the learning model selection policy may include content such as "selecting a learning model of a person related to a company where the user works with the highest priority" or "selecting a learning model by preferentially using work history over educational background."

Alternatively, the service control unit 205 may select a learning model using training data information of each learning model. For example, in a case where the user is a young woman, the service control unit 205 selects a learning model generated using SNS post messages as training data. In contrast, in a case where the user is an elderly man, the service control unit 205 selects a learning model generated using books as training data.

As described above, the service control unit 205 may select a learning model for answering a question from a service user from among a plurality of learning models, based on attribute information of the service user specified by the matching processing and information of each of the plurality of learning models. More specifically, the service control unit 205 may select a learning model for answering a question from the service user from among the plurality of learning models, based on at least one of age group, gender, educational background, and work history of the specified service user.

Upon selecting a learning model, the service control unit 205 receives question data from the terminal 20 of the user (step S102).

The service control unit 205 generates a prompt for inputting to the selected learning model by using the received question data (step S103).

For example, the service control unit 205 generates a prompt such as "User question: I am troubled because my work is not going well. Please answer."

The service control unit 205 acquires an answer by inputting the generated prompt to the selected learning model (step S104).

The service control unit 205 transmits the acquired answer as answer data to the terminal 20 (step S105).

The service control unit 205 repeats the processing from step S102 to step S105 until questions of the user are finished. In generating the prompt in step S103, the service control unit 205 may replace "I am troubled because my work is not going well." in the exemplified prompt with a new question acquired from the user.

The storage unit 206 is means for storing information necessary for operations of the server apparatus 10. For example, the storage unit 206 stores a plurality of learning models characterized by training data. The storage unit 206 stores the plurality of learning models and information of each of the plurality of learning models. The storage unit 206 stores biometric information and attribute information of each of a plurality of users in association with each other.

### Terminal

A detailed description related to the terminal 20 will be omitted. Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate with the server apparatus 10.

Further, existing speech recognition technology or the like can be used for a technique in which the terminal 20 converts voice data into text data, or a technique in which the terminal 20 converts text data into voice data. Accordingly, a detailed description related to the conversion of such voice data will be omitted.

Next, variations according to the first example embodiment will be described.

### Variation 1

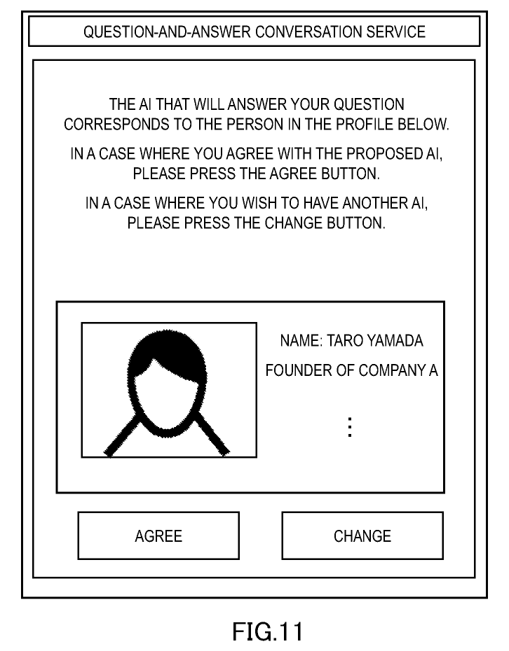

The server apparatus 10 may acquire consent from the user regarding provision of a service using the selected learning model before starting a conversation with the user. For example, upon completing selection of a learning model, the service control unit 205 displays a GUI (Graphical User Interface) as shown in FIG. 11 on the terminal 20.

The service control unit 205 reads out person information and the like corresponding to the selected learning model from the learning model management database, and generates a screen such as that shown in FIG. 11.

In a case where the user agrees that the service is provided using the presented (proposed) learning model (in a case where a consent button is pressed), the service control unit 205 provides the question answering service using the learning model for which the consent has been obtained.

In a case where the user rejects the presented learning model (in a case where a change button is pressed), the service control unit 205 selects a new learning model from among the plurality of learning models, and re-presents the selected learning model to the user. For example, the service control unit 205 acquires consent from the user regarding provision of the service using the reselected learning model by using a GUI similar to that shown in FIG. 11.

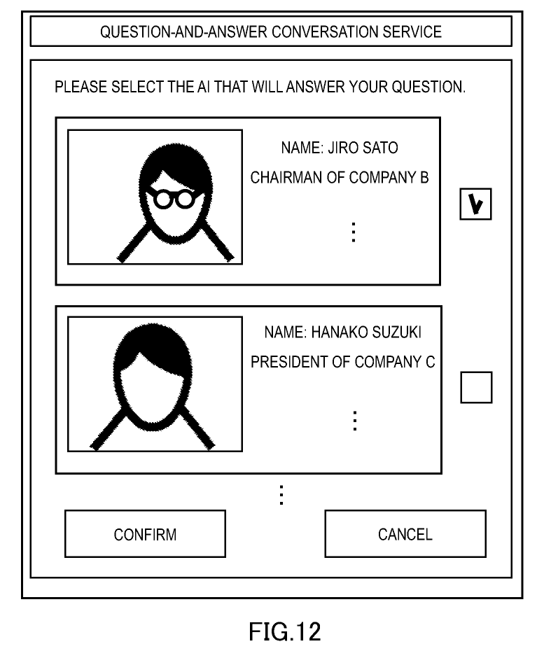

Alternatively, in a case where the user rejects the presented learning model, the service control unit 205 displays on the terminal 20 a GUI that allows the user to select a learning model to be used for providing the service from among a plurality of learning models. For example, the service control unit 205 reads out information from the learning model management database, and displays on the terminal 20 a GUI such as that shown in FIG. 12.

The service control unit 205 provides a service (a question answering service) by using the learning model selected by the user.

As described above, the service control unit 205 may present to the service user the learning model selected based on attribute information of the user or the like, as a learning model for answering a question from the service user. In a case where the service user agrees that the presented learning model is used for providing the service, the service control unit 205 may answer a question from the service user by using the learning model for which the consent has been obtained.

### Variation 2

In the above example embodiment, the server apparatus 10 has been described in a case where a learning model for answering a question or the like from the user is selected before acquiring question data from the terminal 20. However, the service control unit 205 may select a learning model after accepting an initial question or doubt from the user.

In such a case, the service control unit 205 may select a learning model for answering the question of the user by using the initial question or the like of the user. For example, the service control unit 205 may select a learning model by instructing a large language model to select a learning model suitable for answering the question.

### Variation 3

The server apparatus 10 may select a learning model for answering a question or the like of the user by analyzing a still image, a video, or the like in which the user appears. In this case, the terminal 20 transmits, in real time, image data obtained by capturing the user with a camera to the server apparatus 10.

For example, the service control unit 205 analyzes the acquired image data and estimates an emotion of the user. The service control unit 205 acquires the emotion of the user from an emotion estimation learning model obtained through machine learning, by inputting image data (a still image or a video) received from the terminal 20 to the learning model.

The service control unit 205 may select a learning model for answering a question or the like of the user based on the estimated emotion of the user. For example, the service control unit 205 refers to table information that associates emotions (for example, joy, anger, sorrow, pleasure, satisfaction, dissatisfaction) with learning models to be selected, and selects a learning model corresponding to a current emotion of the user.

As described above, the service control unit 205 may acquire image data in which the service user appears from the terminal 20, and may estimate the emotion of the service user by using the acquired image data. Further, the service control unit 205 may select a learning model for answering a question from the service user from among the plurality of learning models based on the estimated emotion.

### Variation 4

The server apparatus 10 may change a learning model for answering a question from the user at any timing. For example, the service control unit 205 may change the learning model that generates an answer to a question at a timing when contents of a question of the user have greatly changed, or at a timing when an emotion of the user has greatly changed.

For example, the service control unit 205 may change the learning model for answering according to a conversation history between the user and the learning model, or according to a change in the estimated emotion. For example, in a case where the emotion of the user changes from "satisfaction" to "dissatisfaction," the service control unit 205 determines that a gap arises between an answer desired by the user and an answer provided by the learning model, and changes the learning model for answering. As described above, the service control unit 205 may determine, from a conversation history between the user and the learning model, that the emotion of the user has changed, and may change the learning model for answering. Alternatively, the service control unit 205 may detect an emotional change of the user from a facial expression of the user or the like, in addition to the conversation history and a voice of the user.

Alternatively, the service control unit 205 may analyze voice data of the user and estimate the emotion of the user. The service control unit 205 may change the learning model used for answering in a case where it is determined, by analyzing the voice data or the image data, that a degree of satisfaction of the user (satisfaction with the answer) is low.

Alternatively, the service control unit 205 may change the learning model for answering a question from the user based on an explicit instruction from the user.

As described above, the service control unit 205 can determine, in real time, an optimal conversation partner (learning model) for the user based on the conversation history and a result of emotion analysis. The server apparatus 10 deepens understanding of thoughts of the user by taking past history of the user into consideration, and realizes improvement in quality of advice by the learning model (improvement in contents of an answer).

### Variation 5

In the above example embodiment, a case has been described in which one learning model answers a question or the like from the user. However, a plurality of learning models may answer the question or the like of the user. The server apparatus 10 may realize a conversation in which one user interacts with a plurality of learning models each based on a different person (for example, a plurality of well-known business managers).

In this case, the service control unit 205 selects a plurality of learning models to converse with the user at a timing such as upon successful authentication of the user. For example, the service control unit 205 selects a plurality of learning models based on age group, career history information, or the like of the user. It should be noted that age group, career history information, or the like of the user is an example of the user information.

The service control unit 205 inputs a prompt generated from a question of the user into each of the above-selected plurality of learning models. Since the training data used for generating each of the plurality of learning models is different, each learning model outputs a different answer to the same prompt.

The service control unit 205 transmits answer data obtained from different learning models to the terminal 20. The terminal 20 presents the answers obtained from the different learning models to the user. For example, the terminal 20 outputs answers (voices) such as "The answer of business manager A is that it is important to act while considering the standpoint of the customer," and "The answer of business manager B is that quick action is important."

Alternatively, the service control unit 205 may combine a plurality of answers obtained from the plurality of learning models into one answer, and may transmit one piece of answer data to the terminal 20. For example, the service control unit 205 may summarize the plurality of answers by using a large language model, and may transmit answer data of the summarized answer to the terminal 20.

As described above, the service control unit 205 may select at least two or more learning models from among the plurality of learning models, and may answer a question from the service user by using the selected at least two or more learning models. Alternatively, the service control unit 205 may summarize answers of each of the at least two or more learning models, and may provide the summarized answer to the service user.

Alternatively, the user may select a learning model with which the conversation is to be continued by referring to answers obtained from the plurality of learning models. In the above example, among the answers of business manager A and business manager B, a learning model corresponding to the business manager who provided an answer closer to the user’s own thought may be selected as a conversation partner.

In this case, the terminal 20 provides a GUI (Graphical User Interface) for allowing the user to select a learning model as a conversation partner, and may notify the server apparatus 10 of the learning model (answer data) selected by the user. The server apparatus 10 may continue to answer a question or the like from the user by using the learning model selected by the user.

It should be noted that the service control unit 205 may realize a conversation between a plurality of learning models selected by the user. Alternatively, the service control unit 205 may realize a conversation between the user and the plurality of learning models.

### Variation 6

In the above example embodiment, the configuration, operation, and the like of the information processing system have been described on the premise that the user enjoys the conversation service at home or the like. However, the user may enjoy the conversation service at a company or the like.

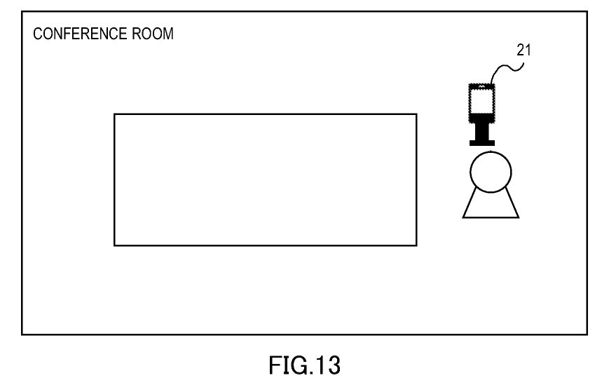

In this case, a signage-type terminal 21 may be installed in a conference room or the like of the company (see FIG. 13). The user may receive provision of the conversation service through the terminal 21.

In contrast to a case where the conversation service is used in a closed space such as a home, in a case where the conversation service is used in an open space such as a company conference room, it becomes more important to authenticate a user by biometric authentication.

### Variation 7

In a case where the terminal 21 is installed in a company conference room or the like, a plurality of users may also receive the provision of the conversation service by using the terminal 21.

The server apparatus 10 provides the conversation service in a case where authentication of at least one of the plurality of users is successful.

Specifically, at least one of the plurality of users receives authentication from the server apparatus 10. Specifically, the terminal 21 acquires biometric information (for example, a face image) of the user in front of the terminal 21. The terminal 21 transmits an authentication request including the acquired biometric information to the server apparatus 10. The server apparatus 10 performs biometric authentication using the biometric information included in the authentication request and a plurality of pieces of biometric information stored in the user management database. The server apparatus 10 specifies a user (service user) who intends to receive the provision of the conversation service by performing biometric authentication. The server apparatus 10 transmits an authentication result (authentication success, authentication failure) to the terminal 21. In a case where authentication is successful, the user is able to enjoy the conversation service.

For example, the service control unit 205 selects a learning model that answers questions from a plurality of users by using attribute information of at least one or more users who have been successfully authenticated.

The service control unit 205 provides the conversation service to a plurality of users in the same manner as in the case of providing the conversation service to one user. In other words, the service control unit 205 generates a prompt to be input to the learning model without distinguishing questioners and inputs the generated prompt into the learning model.

Alternatively, the service control unit 205 may generate a prompt to be input to the learning model while distinguishing questioners. In this case, the terminal 21 may perform voiceprint authentication on utterances (voice data) of each user to identify the questioner. The terminal 21 may identify the questioner by voiceprint authentication and assign an ID (questioner ID) to each questioner. The terminal 21 may transmit the questioner ID together with question data to the server apparatus 10. The service control unit 205 may generate a prompt to be input to the learning model by distinguishing each questioner using the questioner ID received from the terminal 21.

The service control unit 205 may distinguish questioners by using questioner IDs and generate a prompt together with question data.

Alternatively, the service control unit 205 may change the learning model that answers questions of users in accordance with the situation of questions by a plurality of users. For example, the service control unit 205 may estimate emotions of each of the plurality of users and may change the learning model that provides answers in a case where the number of users having negative emotions exceeds a predetermined threshold.

As described above, the server apparatus 10 according to the first example embodiment selects a learning model suitable for a user from among a plurality of learning models and provides a question conversation service using the selected learning model. For example, the server apparatus 10 selects an optimal learning model from among the plurality of learning models on the basis of attributes of the user (for example, age group and work history). As a result, the satisfaction level of a user who uses the conversation service with the learning model is improved. It should be noted that attribute information of the user is an example of user information.

In addition, the user is able to make a personal and private consultation in a space such as the user’s own room by using the terminal 20. The user is able to conduct a one-on-one meeting with the learning model via the terminal 20.

In addition, the server apparatus 10 according to the first example embodiment selects a learning model that answers a question from a service user from among a plurality of learning models. By such an operation of the server apparatus 10, as compared with a case where a large amount of data is trained on one learning model, unnecessary consumption of computational resources is avoided, and the computational speed of the server apparatus 10 is improved.

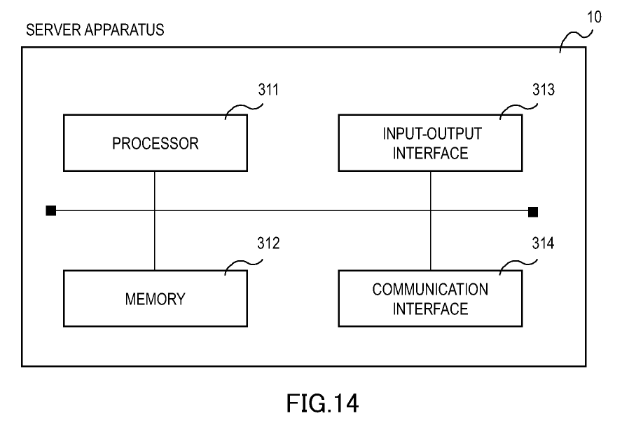

Next, a hardware configuration of an individual apparatus that constitutes the information processing system will be described. FIG. 14 is a diagram illustrating an example of a hardware configuration of the server apparatus 10.

The server apparatus 10 can be configured by an information processing apparatus (a so-called computer) and has a configuration illustrated as an example in FIG. 14. For example, the server apparatus 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 14 is not intended to limit a hardware configuration of the server apparatus 10. The server apparatus 10 may include hardware not illustrated or may be configured without the input-output interface 313 if desired. In addition, the number of components, such as the number of processors 311, included in the server apparatus 10 is not limited to the example illustrated in FIG. 14. For example, a plurality of processors 311 may be included in the server apparatus 10.

The processor 311 is a programmable device such as a CPU (Central Processing Unit), an MPU (Micro Processing Unit), a DSP (Digital Signal Processor), a TPU (Tensor Processing Unit), a GPU ( Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus or an input apparatus that is not illustrated. The display apparatus is, for example, a liquid crystal display or the like. For example, the input apparatus is an apparatus that receives user operations, and examples of the input apparatus include a keyboard, a mouse, and the like.

The communication interface 314 is a circuit, a module, and the like for performing communication with other apparatuses. For example, the communication interface 314 includes a NIC (Network Interface Card) and the like.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that, as is the case with the server apparatus 10, the terminals 20 and 21 can each be configured by an information processing apparatus, and the basic hardware configuration of the terminals 20 and 21 is the same as that of the server apparatus 10. Thus, description of the basic hardware configuration of the terminals 20 and 21 will be omitted.

The server apparatus 10, which is an information processing apparatus, is equipped with a computer, and by causing the computer to execute a program, functions of the server apparatus 10 can be realized. In addition, the server apparatus 10 executes a control method of the server apparatus 10 by using this program.

### Variations

It should be noted that the configuration, operation, and the like of the information processing system described in the above example embodiment are examples, and are not intended to limit the configuration of the system.

The information processing system of the present disclosure can also be used in events or the like. For example, the server apparatus 10 may use a learning model to provide answers to questions from visitors. Alternatively, the information processing system of the present disclosure may be used in educational settings or the like. For example, a student may ask questions using a learning model as a teacher. Alternatively, a teacher may ask questions using a learning model as a student.

In the above example embodiment, the information processing system has been described by taking as an example a case where the server apparatus 10 provides a question answering service. However, the question answering service may be realized by the terminal 20 of a user in which a predetermined application is installed.

In the above example embodiment, the configuration and operation of the information processing system have been described by taking as an example a question answering service in which a user consults about work-related concerns or the like. However, it is natural that the themes targeted by the question answering service are not limited to work-related concerns or the like. For example, a question answering service that targets themes such as concerns in daily life or concerns in child-rearing may be provided.

The server apparatus 10 may prepare a plurality of learning models for each of a plurality of themes, and may select a learning model for conversing with the user from among the plurality of learning models stored in association with a theme selected by the user.

In the above example embodiment, a case has been described in which conversion between voice data and text data is performed in the terminal 20. However, such conversions may be executed by the server apparatus 10.

In the above example embodiment, a case has been described in which the user and the learning model (the server apparatus 10) converse using voice. However, the conversation between the user and the learning model may be performed using text (sentences).

The server apparatus 10, in a case where presenting to the user a learning model that answers a question from the user, may additionally provide information of a person on whom the learning model is based, or may not provide such person information.

The above example embodiment describe in the case where the user management database, or the like, is configured inside the server apparatus 10, but the database may be established on an external database server, or the like. That is, some of the functions of the server apparatus 10 may be implemented in another server. More specifically, the "service control unit (service control means)", or the like described above, can be implemented in any of the apparatuses included in the system.

While the data exchange between each apparatus (for example, the server apparatus 10 and the terminal 20) is not limited to any particular mode, data exchanged between these apparatuses may be encrypted. It is desirable that personal information of a user, and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiment haｓ been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system that answers a question from a user or the like.

A part or the entirety of the example embodiments described above may be described as in the following supplementary notes, but is not limited to the followings.

### Supplementary Note 1

An information processing apparatus including:

a storage means that stores a plurality of learning models and information of each of the plurality of learning models; and

a service control means that implements a service that answers a question from a service user by using at least one or more learning models among the plurality of learning models, and

wherein the service control means selects the learning model that answers the question from the service user from among the plurality of learning models, based on information of the service user and information of each of the plurality of learning models.

### Supplementary Note 2

The information processing apparatus according to supplementary note 1, wherein the storage means stores biometric information and attribute information of each of a plurality of users in association with each other, and

wherein further includes an authentication means that receives biometric information of an applicant who intends to enjoy the service from a predetermined terminal, and authenticates the service user by executing matching processing using the received biometric information and the stored plurality of biometric information, and

wherein the service control means selects the learning model that answers the question from the service user from among the plurality of learning models, based on the attribute information of the service user specified by the matching processing and the information of each of the plurality of learning models.

### Supplementary Note 3

The information processing apparatus according to supplementary note 2, wherein the service control means selects the learning model that answers the question from the service user from among the plurality of learning models, based on at least one of age group, gender, educational background, and work history of the specified service user.

### Supplementary Note 4

The information processing apparatus according to supplementary note 2, wherein the service control means acquires image data in which the service user appears from the predetermined terminal, estimates emotion of the service user by using the acquired image data, and selects the learning model that answers the question from the service user from among the plurality of learning models based on the estimated emotion.

### Supplementary Note 5

The information processing apparatus according to any one of supplementary notes 1 to 4, wherein the service control means presents to the service user the selected learning model as the learning model that answers the question from the service user, and answers, in a case where the service user agrees that the presented learning model is used for providing the service, the question from the service user by using the learning model for which consent has been obtained.

### Supplementary Note 6

The information processing apparatus according to supplementary note 1, wherein the service control means selects at least two or more learning models from among the plurality of learning models, and answers the question from the service user by using the selected at least two or more learning models.

### Supplementary Note 7

The information processing apparatus according to supplementary note 6, wherein the service control means summarizes answers of each of the at least two or more learning models, and provides the summarized answer to the service user.

### Supplementary Note 8

The information processing apparatus according to any one of supplementary notes 1 to 4, wherein each of the plurality of learning models is a learning model in which a way of thinking of one person is reflected.

### Supplementary Note 9

A control method of an information processing apparatus, the control method including:

storing a plurality of learning models and information of each of the plurality of learning models;

implementing a service that answers a question from a service user by using at least one or more learning models among the plurality of learning models; and

selecting the learning model that answers the question from the service user from among the plurality of learning models, based on information of the service user and information of each of the plurality of learning models.

### Supplementary Note 10

A program causing a computer mounted on an information processing apparatus to perform processing for:

storing a plurality of learning models and information of each of the plurality of learning models;

implementing a service that answers a question from a service user by using at least one or more learning models among the plurality of learning models; and

selecting the learning model that answers the question from the service user from among the plurality of learning models, based on information of the service user and information of each of the plurality of learning models.

In addition, a part or all of the configurations described in supplementary notes 2 to 8, which depend on supplementary note 1 described above, may also depend on supplementary notes 9 and 10 in the same dependency relationship as supplementary notes 2 to 8. Furthermore, not limited to supplementary note 1, supplementary note 11, and supplementary note 21, within a scope not departing from each of the above-described example embodiments, a part or all of the configurations described as supplementary notes may similarly be made dependent on various hardware, software, various recording means for recording software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus comprising:
at least one memory storing a set of instructions; and
at least one processor configured to execute the set of instructions to:
store a plurality of learning models and information of each of the plurality of learning models;
implement a service that answers a question from a service user by using at least one or more learning models among the plurality of learning models; and
select the learning model that answers the question from the service user from among the plurality of learning models, based on information of the service user and information of each of the plurality of learning models.

2. The information processing apparatus according to claim 1, wherein
the at least one processor is further configured to execute the set of instructions to:
store biometric information and attribute information of each of a plurality of users in association with each other;
receive biometric information of an applicant who intends to enjoy the service from a predetermined terminal;
authenticate the service user by executing matching processing using the received biometric information and the stored plurality of biometric information; and
select the learning model that answers the question from the service user from among the plurality of learning models, based on the attribute information of the service user specified by the matching processing and the information of each of the plurality of learning models.

3. The information processing apparatus according to claim 2, wherein
the at least one processor is further configured to execute the set of instructions to select the learning model that answers the question from the service user from among the plurality of learning models, based on at least one of age, gender, educational background, and work history of the specified service user.

4. The information processing apparatus according to claim 2, wherein
the at least one processor is further configured to execute the set of instructions to:
acquire image data in which the service user appears from the predetermined terminal;
estimate emotion of the service user by using the acquired image data; and
select the learning model that answers the question from the service user from among the plurality of learning models based on the estimated emotion.

5. The information processing apparatus according to claim 1, wherein
the at least one processor is further configured to execute the set of instructions to:
present to the service user the selected learning model as the learning model that answers the question from the service user; and answer, in a case where the service user agrees that the presented learning model is used for providing the service, the question from the service user by using the learning model for which consent has been obtained.

6. The information processing apparatus according to claim 2, wherein
the at least one processor is further configured to execute the set of instructions to:
present to the service user the selected learning model as the learning model that answers the question from the service user; and answer, in a case where the service user agrees that the presented learning model is used for providing the service, the question from the service user by using the learning model for which consent has been obtained.

7. The information processing apparatus according to claim 3, wherein
the at least one processor is further configured to execute the set of instructions to:
present to the service user the selected learning model as the learning model that answers the question from the service user; and answer, in a case where the service user agrees that the presented learning model is used for providing the service, the question from the service user by using the learning model for which consent has been obtained.

8. The information processing apparatus according to claim 4, wherein
the at least one processor is further configured to execute the set of instructions to:
present to the service user the selected learning model as the learning model that answers the question from the service user; and answer, in a case where the service user agrees that the presented learning model is used for providing the service, the question from the service user by using the learning model for which consent has been obtained.

9. The information processing apparatus according to claim 1, wherein
the at least one processor is further configured to execute the set of instructions to:
select at least two or more learning models from among the plurality of learning models; and
answer the question from the service user by using the selected at least two or more learning models.

10. The information processing apparatus according to claim 9, wherein
the at least one processor is further configured to execute the set of instructions to:
summarize answers of each of the at least two or more learning models; and
provide the summarized answer to the service user.

11. The information processing apparatus according to claim 1, wherein each of the plurality of learning models is a learning model in which a way of thinking of one person is reflected.

12. A control method of an information processing apparatus, the control method comprising:
storing a plurality of learning models and information of each of the plurality of learning models;
implementing a service that answers a question from a service user by using at least one or more learning models among the plurality of learning models; and
selecting the learning model that answers the question from the service user from among the plurality of learning models, based on information of the service user and information of each of the plurality of learning models.

13. A non-transitory computer-readable storage medium storing a program causing a computer mounted on an information processing apparatus to perform processing for:
storing a plurality of learning models and information of each of the plurality of learning models;
implementing a service that answers a question from a service user by using at least one or more learning models among the plurality of learning models; and
selecting the learning model that answers the question from the service user from among the plurality of learning models, based on information of the service user and information of each of the plurality of learning models.
